(19) United States
(12) Patent Application Publication
(10) Pub. No.: US 2015/0049076 A1
(43) Pub. Date: Feb. 19, 2015

(54) DISPLAY DRIVING CIRCUIT AND DISPLAY DEVICE

(71) Applicant: Samsung Electronics Co., Ltd., Suwon-si (KR)

(72) Inventors: Yang-hyo KIM, Suwon-si (KR); Sang-min LEE, Seongnam-si (KR); Won-sik KANG, Seoul (KR); Jun-hong PARK, Seoul (KR); Jong-kon BAE, Seoul (KR); Jae-hyuck WOO, Osan-si (KR); In-suk KIM, Suwon-si (KR); Sung-jin PARK, Hwaseong-si (KR)

(73) Assignee: SAMSUNG ELECTRONICS CO., LTD, Suwon-si (KR)

(21) Appl. No.: 14/452,644

(22) Filed: Aug. 6, 2014

(30) Foreign Application Priority Data
Aug. 16, 2013 (KR) 10-2013-0097317

(51) Int. Cl. G09G 5/18

(52) U.S. Cl. CPC G09G 5/18; G09G 2330/028
USPC 345/212

(57) ABSTRACT

A display device includes a timing controller to generate a plurality of data control signals, a source driving unit to receive the plurality of data control signals from the timing controller and generate a data voltage, and a display panel to receive the data voltage and output an image, wherein the source driving unit transmits the data voltage to the display panel, through a plurality of data lines, with delays that are respectively different corresponding each frame.

### CROSS-REFERENCE TO RELATED APPLICATIONS

This application claims priority under 35 U.S.C. §119 from Korean Patent Application No. 10-2013-0097317, filed on Aug. 16, 2013, in the Korean Intellectual Property Office, the disclosure of which is incorporated herein in its entirety by reference.

### BACKGROUND

1. Field

The present general inventive concept relates to a display driving circuit and a display device, and more particularly, to a display driving circuit and a display device, which prevent noise generation due to electro magnetic interference (EMI).

2. Description of the Related Art

Recently, as more and more data is processed in a display driving circuit, an amount of current used in the display driving circuit is also increasing. Particularly, an enlarged display screen of a flat display device, high resolution, and an improvement in image quality of a panel are causing an increase in a chance of occurrence of noise generation in the panel, caused by electro magnetic interference (EMI). Also, the flat display device is used in combination with other components including complex equipment and a touch sensor. Thus, because interference and noise may occur between used signals, equipment malfunctions may occur.

Such noise due to the EMI is generated in the panel resulting from a temporary output of various signals to drive the display device. Thus, malfunctions of a device may be avoided by reducing noise generation.

### SUMMARY

The present general inventive concept provides a display driving circuit and a display device, which prevent noise generation resulting from to electro magnetic interference (EMI).

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a display device including a timing controller to generate a plurality of data control signals, a source driving unit to receive the plurality of data control signals from the timing controller and generating a data voltage, and a display panel to receive the data voltage and outputting an image, wherein the source driving unit transmits the data voltage to the display panel, through a plurality of data lines, with delays that are respectively different corresponding to each frame.

The display panel may output the image by compensating the delays that are respectively different corresponding to each frame.

The source driving unit may include a plurality of source drivers, and, the source driving unit including the plurality of source drivers generates the data voltage with delays that are respectively different.

The timing controller may transmit the plurality of data control signals to the source driving unit with random delays.

The source driving unit may include a plurality of source drivers, and, the timing controller transmits the plurality of data signals to the plurality of source drivers with random delays.

The source driving unit may include a plurality of source channels that are respectively connected to the plurality of data lines, and, each of the plurality of source channels transmits the data voltage to the display panel with a delay that is different.

The display device may include a clock controller, and, the clock controller may include a clock pattern generator to generate a clock pattern signal, a clock generator to receive the clock pattern signal and to generate at least one preliminary clock signal, a synchronization compensator to receive the clock pattern signal and to generate at least one compensation clock signal corresponding to a frequency of the at least one preliminary clock signal, and a divider to generate at least one clock signal by merging the at least one preliminary clock signal received from the clock generator and the at least one compensation clock signal received from the synchronization compensator, wherein the at least one clock signal is transmitted to the timing controller.

The at least one clock signal may have a frequency within a predetermined range.

The clock pattern signal may be predetermined in consideration of a frame frequency.

The clock pattern signal may be changed in a horizontal line unit of the image output from the display panel or is changed in a frame unit.

The data control signal may include color data including at least two pieces of sub-color data, and, the source driving unit may transmit the data voltage to the display panel, with delays that are respectively different corresponding to each of the at least two pieces of sub-color data.

The foregoing and/or other features and utilities of the present general inventive concept may also be achieved by providing a timing controller to generate a plurality of data control signals, and a source driving unit to receive the plurality of data control signals from the timing controller and generating a data voltage, wherein the source driving unit transmits the data voltage to a display panel through a plurality of data lines, with delays that are respectively different corresponding to each frame.

The display panel may output a picture image by compensating the delays that are respectively different corresponding to each frame.

The display driving device may include a clock controller, and, the clock controller may include a clock pattern generator to generate a clock pattern signal, a clock generator to receive the clock pattern signal and generating at least one preliminary clock signal, a synchronization compensator to receive the clock pattern signal and to generate at least one compensation clock signal corresponding to a frequency of the at least one preliminary clock signal, and a divider to generate at least one clock signal by merging the at least one preliminary clock signal received from the clock generator and the at least one compensation clock signal received from the synchronization compensator, wherein the at least one clock signal is transmitted to the timing controller.

The data control signal may include color data including at least two pieces of sub-color data, and, the source driving unit may transmit the data voltage to the display panel, with delays that are respectively different corresponding each of the at least two pieces of sub-color data.

The foregoing and/or other features and utilities of the present general inventive concept may also be achieved by providing a display driving device including a source driving unit to generate a data voltage based on a plurality of received data control signals corresponding to timing signals, and a display panel to receive the data voltage through a plurality of data lines having delays that are respectively different corresponding to each frame.

The display device of claim may further include a timing controller to generate the plurality of data control signals.

The plurality of data control signals may correspond to at least one of respective source channels, respective frames, and respective horizontal synchronization lines having different respective delays.

The timing signals may correspond to at least one of data, a vertical synchronization signal, a horizontal synchronization signal, a clock signal, and a data enable signal.

The display panel may output an image by a plurality of pixels by receiving the data voltage transmitted with the respective delays from the source driving unit and compensating the respective delays.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram of a display device according to an exemplary embodiment of the present general inventive concept;

FIG. 2 is a view illustrating in detail a source driving unit according to an exemplary embodiment of the present general inventive concept;

FIG. 3 is a graph illustrating a distribution of delays that a data voltage supplied by first through third source drivers of FIG. 2 has, according to an exemplary embodiment of the present general inventive concept;

FIG. 4 is a view illustrating in detail a source driving unit according to another exemplary embodiment of the present general inventive concept;

FIGS. 5A and 5B are views illustrating a first source driver according to another exemplary embodiment of the present general inventive concept;

FIGS. 6A and 6B are timing diagrams illustrating a time period in which first through fifth multiplexer signals are activated in the first source driver of FIG. 5;

FIG. 7 is a block diagram of a display device according to an exemplary embodiment of the present general inventive concept;

FIG. 8 is a view illustrating in detail a clock control unit of FIG. 7;

FIG. 9 is a view illustrating in detail a clock pattern generator;

FIG. 10 is a timing diagram with respect to a preliminary clock signal generated in a clock generator;

FIG. 11 is a view illustrating a display module according to an exemplary embodiment of the present general inventive concept;

FIG. 12 is a block diagram of a display chip integrated circuit (IC) according to an exemplary embodiment of the present general inventive concept;

FIG. 13 is a view illustrating a display system according to an exemplary embodiment of the present general inventive concept; and

FIG. 14 is a view illustrating diverse exemplary applications of electronic goods including a display device, according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The terminology used herein is for describing particular embodiments and is not intended to be limiting of exemplary embodiments. As used herein, the singular forms “a,” “an,” and “the,” are intended to include the plural forms as well, unless the context clearly displays otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items.

Unless otherwise defined, all terms (including technical and scientific terms) used herein have the same meaning as commonly understood in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

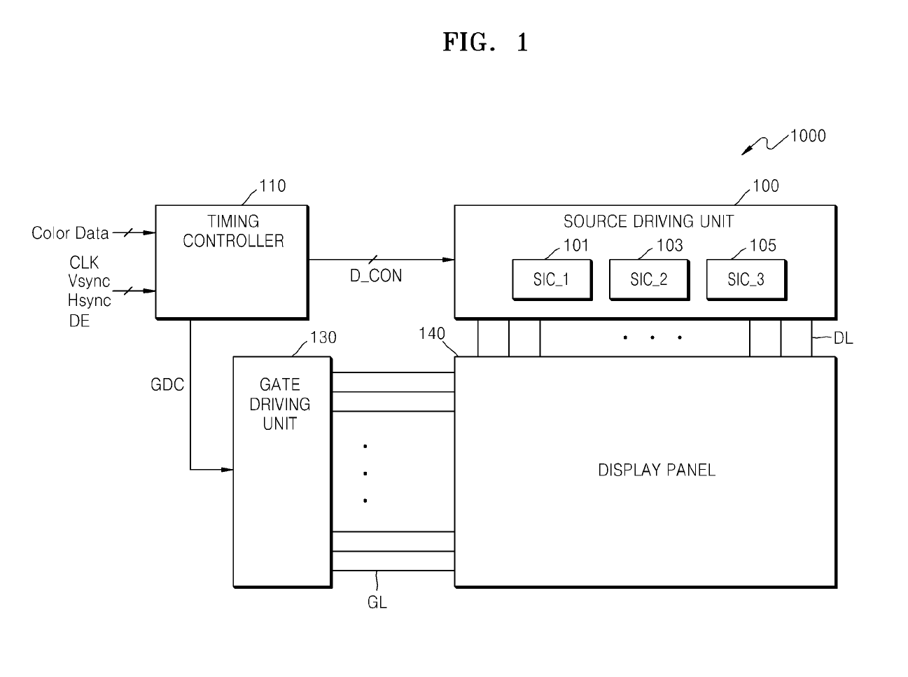

FIG. 1 is a block diagram of a display device according to an exemplary embodiment of the present general inventive concept.

Referring to FIG. 1, the display device 1000 may include a display panel 140, a timing controller 110, a source driving unit 100, and a gate driving unit 130.

The timing controller 110 generates a data control signal D_CON to control an operation time of the source driving unit 100, and a gate control signal GDC to control an operation time of the gate driving unit 130, based on timing signals including color data, a vertical synchronization signal Vsync, a horizontal synchronization signal Hsync, a clock signal CLK, and a data enable signal DE.

The timing controller 110 according to FIG. 1 may transmit a plurality of data control signals D_CON corresponding to respective source channels, respective frames, or respective horizontal synchronization lines, to the source driving unit 100, with delays that are respectively different. Thus, electro magnetic interference (EMI) generation resulting from to signals, such as the plurality of data control signals D_CON, transmitted from the timing controller 110 to the source driving unit 100, may be minimized.

For example, the timing controller 110 may transmit the data control signal D_CON to the source driving unit 100 with a delay t1, with respect to a plurality of data control signals D_CON corresponding to a first frame. Alternatively, the timing controller 110 may transmit the data control signal D_CON to the source driving unit 100 with a delay t2, with respect to a plurality of data control signals D_CON corresponding to a second frame.

For example, the timing controller 110 may transmit the data control signal D_CON to the source driving unit 100 with a delay t3, with respect to a plurality of data control signals D_CON corresponding to a first horizontal synchronization line of the first frame. Alternatively, the timing controller 110 may transmit the data control signal D_CON to the source driving unit 100 with a delay t4, with respect to a plurality of data control signals D_CON corresponding to a second horizontal synchronization line of the first frame.

For example, the timing controller 110 may transmit the data control signal D_CON to the source driving unit 100 with a delay t5, with respect to a plurality of data control signals D_CON corresponding to the first horizontal synchronization line of the first frame and a first source channel. Alternatively, the timing controller 110 may transmit the data control signal D_CON to the source driving unit 100 with a delay t6, with respect to a plurality of data control signals D_CON corresponding to the first horizontal synchronization line of the first frame and a second source channel.

The timing controller 110 according to another exemplary embodiment of the present general inventive concept may transmit a plurality of data control signals D_CON corresponding to respective source channels, respective frames, or respective horizontal synchronization lines, to the source driving unit 100, with delays that are randomly predetermined.

The source driving unit 100 may receive the plurality of data control signals D_CON from the timing controller 110. Also, the source driving unit 100 may separate the plurality of data control signals D_CON that are received in series into color data and clock data CLK. Moreover, the source driving unit 100 may convert the color data into a data voltage of an analogue format, synchronize the data voltage according to the clock data CLK, and supply the synchronized data voltage to data lines DL.

The source driving unit 100 may include a plurality of source drivers SIC1, SIC2, and SIC 3. In FIG. 1, although the number of the source drivers included in the source driving unit 100 is three, the number of the source drivers included in the source driving unit 100 does not limit the scope of the present general inventive concept. For example, according to another exemplary embodiment, the source driving unit 100 may include three or more source drivers.

The source driving unit 100 according to an exemplary embodiment of the present general inventive concept may supply a plurality of data voltages to the data lines DL, with delays that are randomly predetermined according to respective data voltages corresponding to respective source channels, respective frames, or respective horizontal synchronization lines. Thus, the EMI generation due to the signals transmitted from the timing controller 110 to the source driving unit 100 may be minimized.

The gate driving unit 130 selects a horizontal synchronization line through which the data voltage is applied, by generating scan pulses under control of the timing controller 110 and sequentially supplying the scan pulses to gate lines GL.

A plurality of the data lines DL and a plurality of the gate lines GL are crossed on the display panel 140. Also, a plurality of pixels are arranged in a portion of the display panel, where the plurality of the data lines DL and the plurality of the gate lines GL are crossed.

The display panel 140 according to an exemplary embodiment of the present general inventive concept may output an image by the plurality of pixels, by receiving the data voltage transmitted with the respective delays from the source driving unit 100 and compensating the respective delays.

The display device according to the exemplary embodiment of the present general inventive concept may minimize the EMI generation by reducing a periodicity of current flows transmitted and received. A more detailed structure and operation will be described later below.

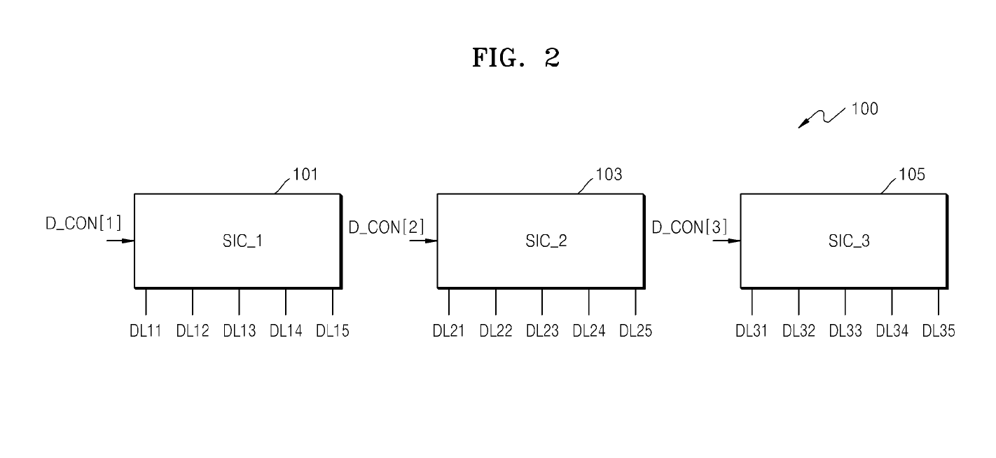

FIG. 2 is a view illustrating in detail a source driving unit 100, according to an exemplary embodiment of the present general inventive concept.

Referring to FIG. 2, the source driving unit 100 may include a plurality of source drivers. For example, the source driving unit 100 may include a first source driver through a third source driver 101, 103, and 105.

The first source driver 101 may select and receive only a first data control signal D_CON [1] corresponding to the first source driver 101, from among a plurality of data control signals D_CON (refer to FIG. 1) received in the source driver unit 100. The first source driver 101 may separate the first data control signal D_CON [1] into color data and clock data.

The first source driver 101 may convert the color data separated from the first data control signal D_CON [1] into a data voltage of an analogue format. Also, the first source driver 101 may synchronize the data voltage according to the clock data separated from the first data control signal D_CON [1], and supply the synchronized data voltage to the display panel 150 of FIG. 1 through the data lines DL 11, DL 12, DL 13, DL 14, and DL 15.

In a similar manner with the first source driver 101, the second source driver 103 and the third source driver 105 may also operate. For example, the second source driver 103 may select and receive only a second data control signal D_CON [2], and, the second source driver 103 may separate the second data control signal D_CON [2] into color data and clock data. Also, the second source driver 103 may supply a data voltage corresponding to the second data control signal D_CON [2] to the display panel 150 of FIG. 1 through data lines DL21, DL22, DL23, DL24, and DL25.

The number of the source drivers included in the source driving unit 100 is illustrated as three according to FIG. 2. However, this does not limit the scope of the present general inventive concept, and the number may vary according to exemplary embodiments.

The first source driver according to an exemplary embodiment of the present general inventive concept may supply the data voltage provided through the respective data lines DL11, DL12, DL13, DL14, and DL15 to the display panel 150 of FIG. 1, with delays that are respectively different, or that are randomly predetermined.

Likewise, the second source driver 103 and the third source driver 105 according to an exemplary embodiment of the present general inventive concept may transmit the data voltage to the display panel 150 of FIG. 1 with delays that are different according to the respective data lines DL11, DL12, DL13, DL14, and DL15 or with delays that are randomly predetermined.

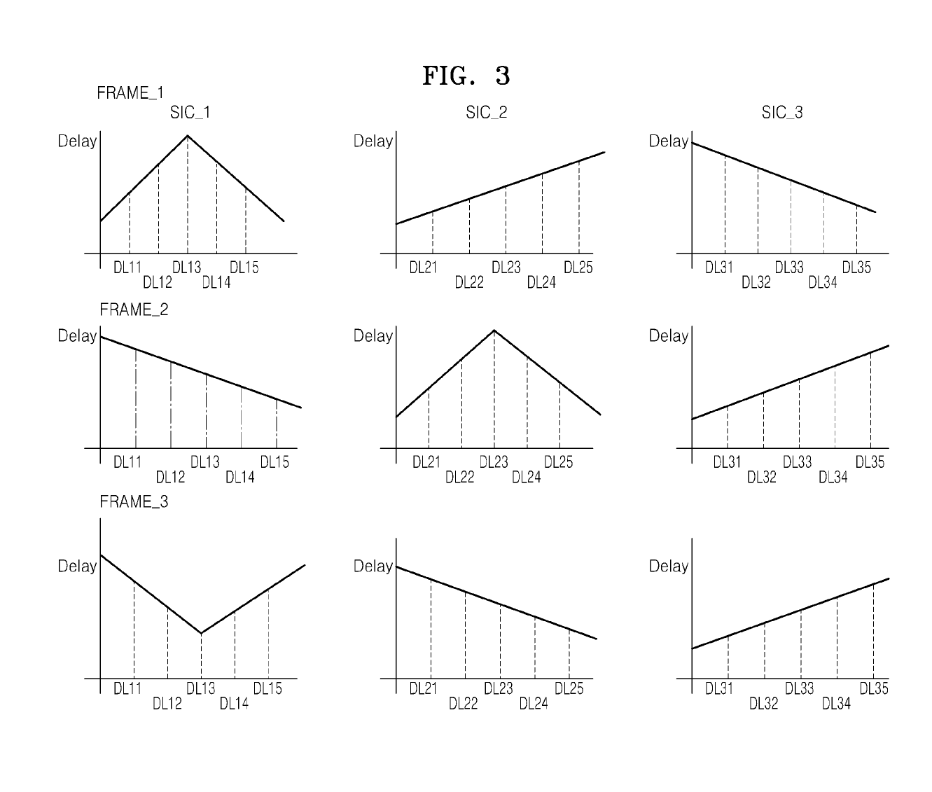

FIG. 3 is a graph illustrating a distribution of delays that a data voltage supplied by a first source driver SIC_1 through a third source driver SIC_3 of FIG. 2 has, according to an exemplary embodiment of the present general inventive concept.

Referring to FIG. 3, the first source driver SIC_1 may supply a data voltage with delays that are respectively different according to the respective data lines DL11, DL12, DL13, DL14, and DL15. Also, the data line DL11 of the first source driver SIC_1 may supply a data voltage with delays that are respectively different according to respective frames. In addition, the first source driver SIC_1 may supply the data voltage with a delay that is different from the delays of the second source driver SIC_2 and the third source driver SIC_3. According to another exemplary embodiment of the present general inventive concept, the first source driver SIC_1 through the third source driver SIC_3 may supply a data voltage with delays that are randomly predetermined corresponding to the respective frames and respective data lines DL11, DL12, DL13, DL14, and DL15.

Thus, according to the display device according to the exemplary embodiment of the present general inventive concept, the EMI generation which may be caused by simultaneous occurrences of current or voltage signals, may be minimized, by setting the delays of the current or the voltage signals that are transmitted and received to be respectively different.

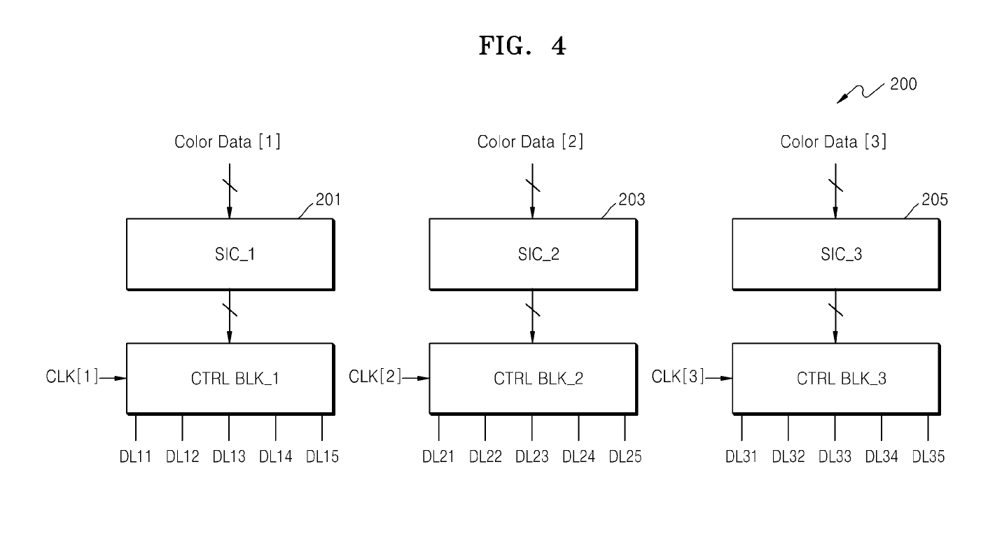

FIG. 4 is a view illustrating in detail a source driving unit 200 according to another exemplary embodiment of the present general inventive concept.

Referring to FIG. 4, the source driving unit 200 may include a first source driving unit through a third driving unit 210, 203, and 205.

The first source driver 201 may select and receive only a first data control signal D_CON [1] corresponding to the first source driver 201 among a plurality of data control signals D_CON (refer to FIG. 1) received in the source driver unit 200. The first source driver 201 may convert color data separated from the first data control signal D_CON [1] into a data voltage of an analogue format. The second source driver 203 and the third source driver 205 may operate in a similar manner.

A first control block CTRL BLK_1 may receive a data voltage converted by the first source driver 201. The first control block CTRL BLK_1 may receive a first clock signal CLK [1]. Here, the first clock signal CLK [1] is a portion of a clock signal CLK, which corresponds to the first source driver 201. The first control block CTRL BLK_1 may supply a data voltage to the respective data lines DL11, DL12, DL13, DL14, and DL15 with delays that are respectively different, according to the first clock signal CLK [1]. A second control block CTRL BLK_2 and a third control block CTRL BLK_3 may operate in a similar manner as the first control block CTRL BLK_1.

That is, unlike the first source driver through the third source driver 101, 103, and 105 of FIG. 2, the first source driver through the third source driver 201, 203, and 205 may receive only color data [1], color data [2], and color data [3] separated from the first data control signal D_CON [1] , and may receive from an additional control block clock signals CLK [1], CLK [2], and CLK [3] separated from the first data control signal D_CON [1].

FIG. 4 illustrates the number of the source drivers included in the source driving unit 200 as three. However, this does not limit the scope of the present general inventive concept, and, the number may vary according to exemplary embodiments.

The first source driver according to the exemplary embodiment of the present general inventive concept may supply a data voltage provided through the respective data lines DL11, DL12, DL13, DL14, and DL15 to the display panel 150 of FIG. 1, with delays that are respectively different corresponding to each of the data lines, or with delays that are randomly predetermined.

The first source driver according to an exemplary embodiment of the present general inventive concept may supply the data voltage provided through the respective data lines DL11, DL12, DL13, DL14, and DL15 to the display panel 150 of FIG. 1, with delays that are respectively different according to each frame or each horizontal synchronization line, or with delays that are randomly predetermined.

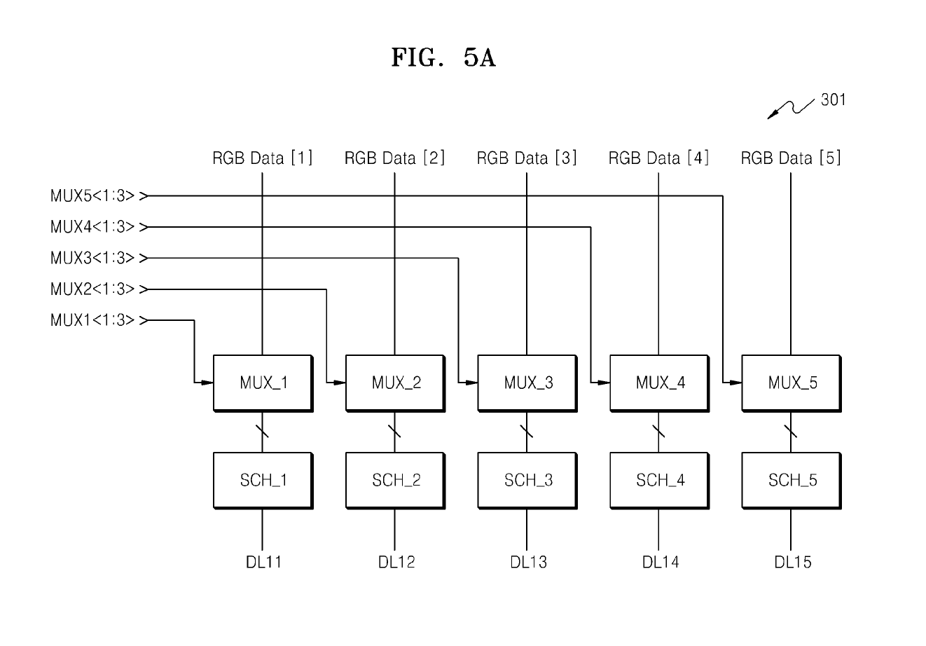

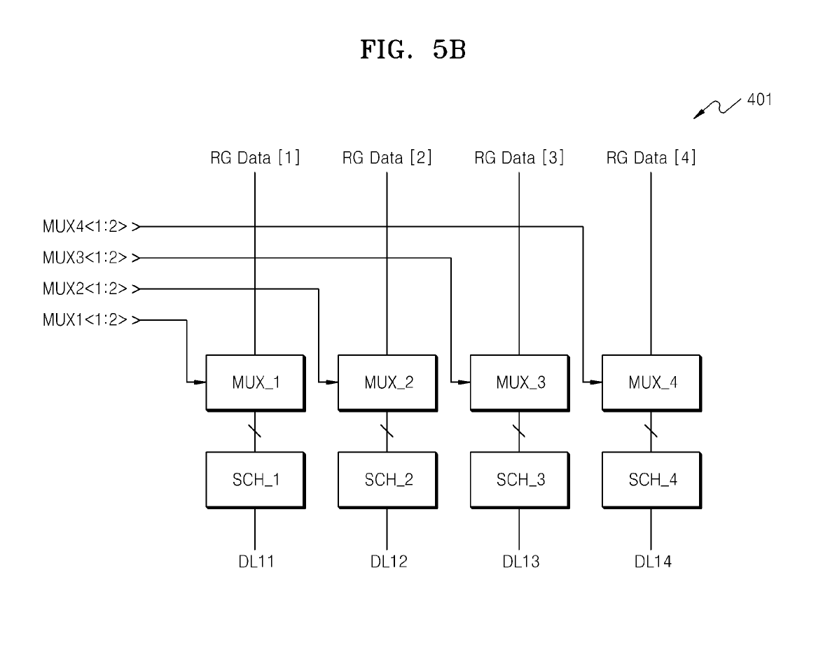

FIG. 5A is a view illustrating a first source driver 301 according to another exemplary embodiment of the present general inventive concept.

The first source driver 301 may include a first multiplexer MUX_1 through a fifth multiplexer MUX_5 and a first source channel SCH_1 through a fifth source channel SCH_5.

The first multiplexer MUX_1 through the fifth multiplexer MUX_5 may respectively receive a first RGB data RGB data [1] through a fifth RGB data RGB data [5]. The first RGB data RGB data [1] through the fifth RGB data RGB data [5] may be a signal generated by the color data of FIG. 1. The first RGB data RGB data [1] may include red, green, and blue data realized in three sub-pixels included in a pixel. The second RGB data RGB data [2] through the fifth RGB data RGB data [5] may include red, green, and blue data like the first RGB data RGB data [1].

The first multiplexer MUX_1 through the fifth multiplexer MUX_5 may respectively receive a first multiplexer signal MUX1 <1:3> through a fifth multiplexer signal MUX5 <1:3>. The first RGB data RGB data [1] through the fifth RGB data RGB data [5] may be a signal generated by the clock data CLK of FIG. 1.

The first multiplexer MUX_1 may receive the first RGB data RGB data [1], and may transmit the respective pieces of data with respect to the three colors, of the first RGB data RGB data [1], to the first source channel, with delays that are respectively different according to the first multiplexer signal MUX1 <1:3>. The second multiplexer MUX_2 through the fifth multiplexer MUX_5 operate in a similar manner.

Although it is described as RGB data in FIG. 5, the scope of the present general inventive concept is not limited to red, green, and blue colors. If there is data of at least one sub-color, it is within the scope of the present general inventive concept.

For example, as illustrated in FIG. 5B, data with respect to a color pixel having a PenTile structure including red and green sub-pixels or blue and green sub-pixels, may also be within the scope of the present general inventive concept.

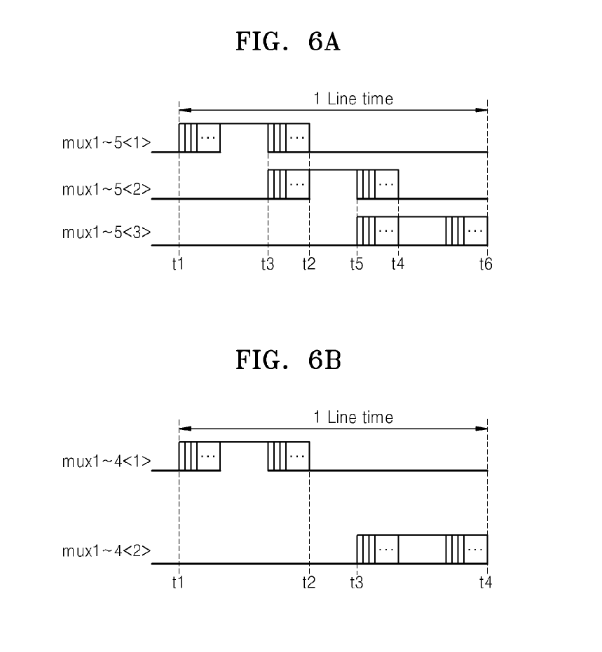

FIG. 6A is a timing diagram illustrating a time period in which a first multiplexer signal MUX1 <1:3> through a fifth multiplexer signal MUX5 <1:3> are activated in the first source driver 301 of FIG. 5A.

Referring to FIGS. 5A and 6A, the first multiplexer signal MUX1 <1> through the fifth multiplexer signal MUX5 <1> may be activated in time periods respectively different between t1 and t2. The first multiplexer signal MUX1 <2> through the fifth multiplexer signal MUX5 <2> may be activated in time periods respectively different between t3 and t4. The first multiplexer signal MUX1 <3> through the fifth multiplexer signal MUX 5 <3> may be activated in time periods respectively different between t5 to t6.

Therefore, the first source driver 301 according to the exemplary embodiment of the present general inventive concept may avoid the EMI generations by transmitting data with respect to three sub-pixels to the source channel in each different time period.

FIG. 6B is a timing diagram illustrating a time period in which a first multiplexer signal MUX1 <1:2> through a fifth multiplexer signal MUX5 <1:3> are activated in the first source driver 301 of FIG. 5B.

Referring to FIGS. 5A and 6A, the first multiplexer signal MUX1 <1> through the fourth multiplexer signal MUX4 <1> may be activated in respective time periods between t1 and t2. The first multiplexer signal MUX1 <2> through the fourth multiplexer signal MUX4 <2> may be activated in respective time periods between t3 and t4.

Therefore, the first source driver 301 according to an exemplary embodiment of the present general inventive concept transmits data with respect to a pixel having a PenTile structure to a source channel in different time periods respectively, thereby avoiding the EMI generation.

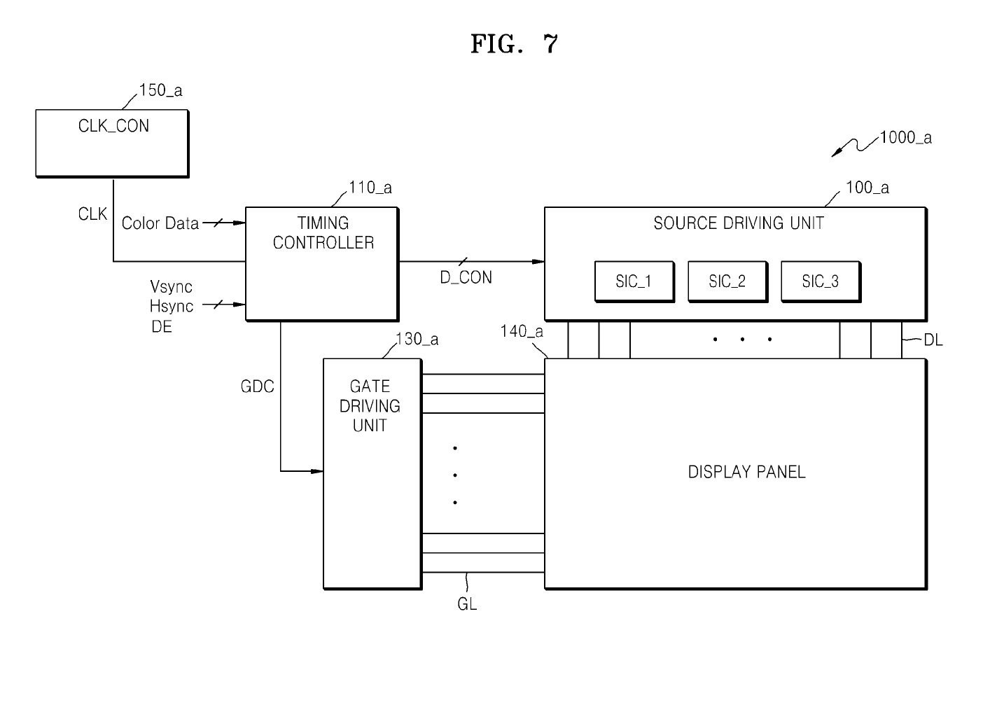

FIG. 7 is a block diagram of a display device 1000_{—}a according to an exemplary embodiment of the present general inventive concept.

Referring to FIG. 7, the display device 1000_{—}a may include a display panel 140_{—}a, a timing controller 110_{—}a, a source driving unit 100_{—}a, a gate driving unit 130_{—}a, and a clock controller 150_{—}a.

The display panel 140_{—}a, the timing controller 110_{—}a, the source driving unit 100_{—}a, and the gate driving unit 130_{—}a may operate in a similar manner as the display panel 140, the timing controller 110, the source driving unit 100, and the gate driving unit 130 of FIG. 1.

The clock controller 150_{—}a generates a clock signal CLK and transmits the signal to the timing controller 110_{—}a. The clock controller 150_{—}a according to an exemplary embodiment of the present general inventive concept transmits a signal generated internally by changing its frequency, thereby avoiding the EMI generation. A more detailed structure and operation will be described later on.

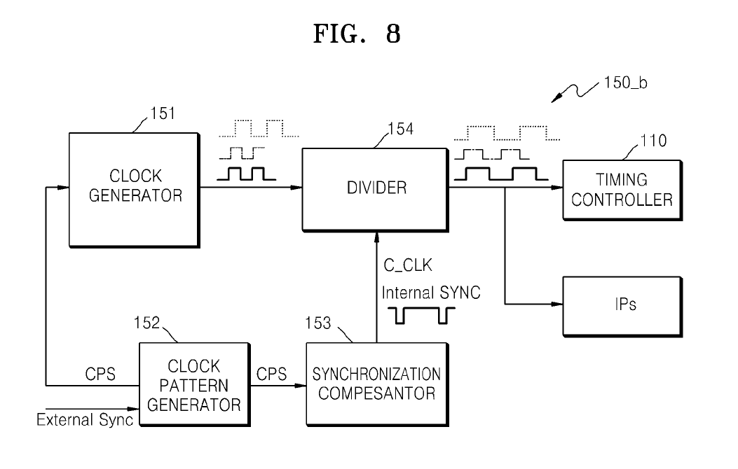

FIG. 8 is a view illustrating in more detail the clock controller 150_{—}a of FIG. 7.

Referring to FIG. 8, the clock controller 150_{—}a may include a clock generator 151, a clock pattern generator 152, a synchronization compensator 153, and a divider 154.

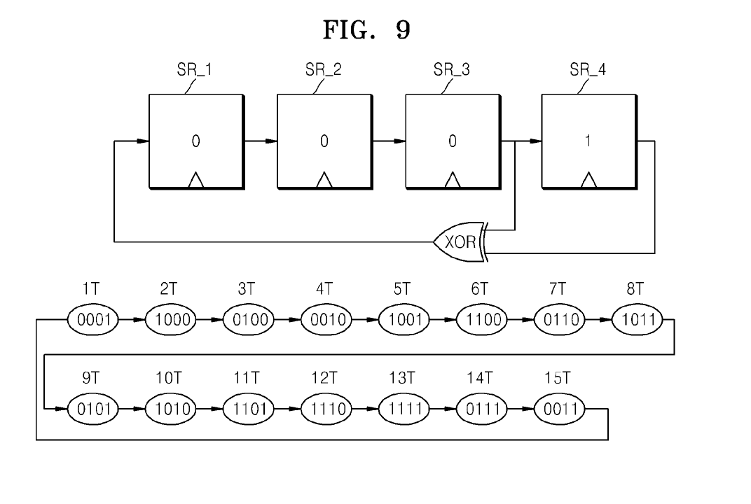

The clock pattern generator 152 may generate a clock pattern signal CPS. The clock pattern signal CPS may be transmitted to the clock generator 151 and the synchronization compensator 153. A method of generating the clock pattern signal CPS of the clock pattern generator 152 will be described with reference to FIG. 9.

FIG. 9 is a view illustrating in detail the clock pattern generator 152.

Referring to FIG. 9, the clock pattern generator 152 may include a first shift resistor SR_1 through a fourth shift resistor SR_4 and an XOR gate. An input of the XOR gate in a first cycle may be values stored in the third shift resistor SR_3 and the fourth shift resistor SR_4. Also, an output of the XOR gate in the first cycle may be stored in the first shift resistor SR_1.

For example, in the first cycle 1T, logic low, logic low, logic low, and logic high may be stored respectively in the first shift resistor SR_1, the second shift resistor SR_2, the third shift resistor SR_3, and the fourth shift resistor SR_4.

In a second cycle 2T, the first shift resistor SR_1 stores logic high, which is the result of an XOR calculation of the logic low and logic high stored in the third shift resistor SR_3 and the fourth shift resistor SR_4 in the first cycle 1T.

In the second cycle 2T, the second shift resistor SR_2 receives the value stored in the first shift resistor SR_1 in the first cycle 1T. That is, in the second cycle 2T, the second shift resistor SR_2 stores the logic high. Similarly, the third shift resistor SR_3 may store the logic low, and the fourth shift resistor SR_4 may store the logic low.

In this manner, the clock pattern generator 152 may sequentially generate the clock pattern signal CPS.

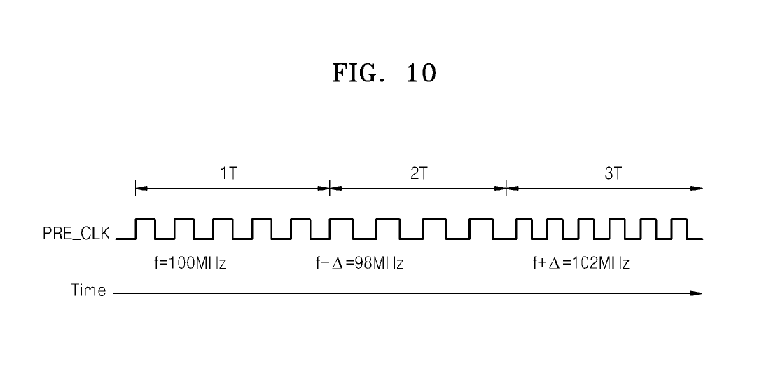

Again referring to FIG. 8, the clock generator 151 receives the clock pattern signal CPS generated from the clock pattern generator 152. The clock generator 151 may generate a preliminary clock signal PRE_CLK according to the clock pattern signal CPS sequentially received. The clock generator 151 may control a frequency of the preliminary clock signal PRE_CLK according to the clock pattern signal CPS sequentially received. The operation of the clock generator 151 will be described in more detail with reference to FIG. 10.

FIG. 10 is a timing diagram with respect to the preliminary clock signal PRE_CLK generated in the clock generator 151.

Referring to FIG. 10, a frequency of the preliminary clock signal PRE_CLK corresponding to the first cycle 1T may be 100 Mhz. Also, a frequency of the preliminary clock signal PRE_CLK corresponding to the second cycle 2T may be 98 Mhz. Moreover, a frequency of the preliminary clock signal PRE_CLK corresponding to a third cycle 3T may be 102 Mhz. Like this, the clock generator 151 may sequentially control the frequency of the preliminary clock signal PRE_CLK.

Again, referring to FIG. 8, the synchronization compensator 153 may receive the clock pattern signal CPS and generate compensation clock signals C_CLK corresponding to the frequencies of the preliminary clock signals PRE_CLK.

The divider 154 may receive the compensation clock signal C_CLK and generate the clock signal CLK by merging the compensation clock signal C_CLK with the preliminary clock signal PRE_CLK. The clock signal CLK may be transmitted to the timing controller 110 of FIG. 1. Also, a clock signal CLK having a frequency two times greater or four times greater than the frequency of the clock signal CLK may be transmitted to other IPs of the display device.

Thus, the clock controller 150_{—}a according to the exemplary embodiment of the present general inventive concept may avoid the EMI generation because the clock controller 150_{—}a generates the preliminary clock signal while the frequency is continually changing, instead of the preliminary clock signal while the frequency remains the same.

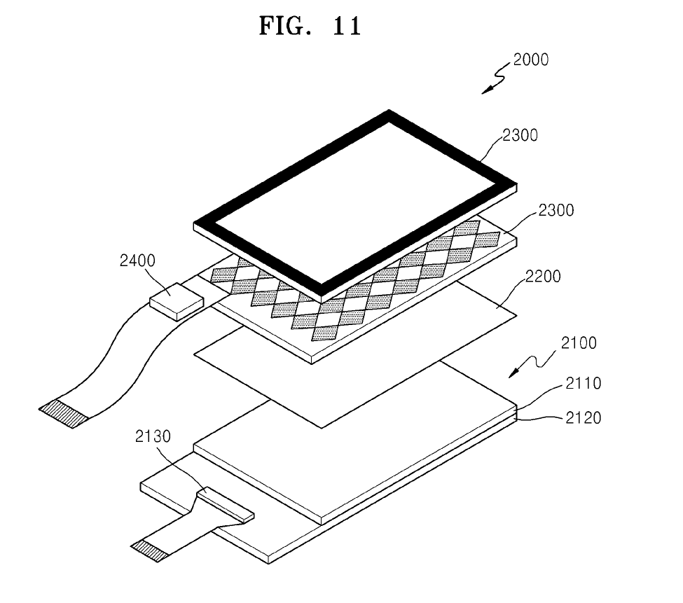

FIG. 11 is a view illustrating a display module according to an exemplary embodiment of the present general inventive concept.

Referring to FIG. 11, the display module 2000 includes a display device 2100, a polarizing film 2200, and window glass 2300. The display device 2100 includes a display panel 2110, a printed board 2120, and a display driving chip 2130.

The window glass 2300 protects the display module 2000 from being scratched by external shocks or repeated touching, and is generally manufactured using acryl or a tempered glass. The polarizing film 2200 may be provided to improve optical characteristics of the display panel 2110. The display panel 2110 is formed on the printed board 2120 by being patterned as a transparent electrode. The display panel 2110 includes a plurality of pixel cells to display frames. According to an exemplary embodiment of the present general inventive concept, the display panel 2110 may be an organic light-emitting diode (OLED) panel. Each of the pixel cells includes an OLED that emits light according to a current flow. However, it is not limited thereto, and, the display panel 2110 may include a variety of display devices. For example, the display panel 2110 may include one of a liquid crystal display (LCD), an electrochromic display (ECD), a digital mirror device (DMD), an actuated mirror device (AMD), a grating light value (GLV), a plasma display panel (PDP), an electro luminescent display (ELD), a light-emitting diode (LED) display, and a vacuum fluorescent display (VFD).

The display driving chip 2130 may include the timing controller 110, the source driving unit 120, and the gate driving unit 130 of FIG. 1. According to the present exemplary embodiment of the present general inventive concept, the display driving chip 2130 is illustrated to include one chip, but it is not limited thereto. A plurality of driving chips may be provided. Also, the display driving chip 2130 may have a form of a chip on glass (COG) mounted on the printed board 2120 formed of a glass material. However, it is only an example, and the display driving chip 2130 may be provided in various forms including a chip on film (COF) and a chip on board (COB).

The display module 2000 may further include a touch panel 2300 and a touch controller 2400. The touch panel 2300 is formed by patterning a transparent electrode, such as indium tin oxide (ITO), on a glass substrate or a polyethylene terephthlate (PET) film. The touch controller 2400 senses a touch on the touch panel 2300, calculates touch coordinates, and transmits the touch coordinates to a host (not illustrated). The touch controller 2400 may be integrated in the display driving chip 2130 and one semiconductor chip.

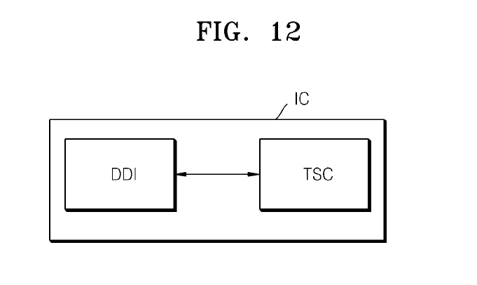

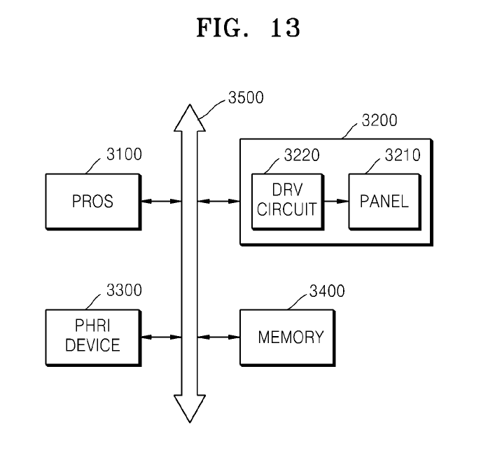

FIG. 12 is a block diagram of a display chip integrated circuit (IC), according to an exemplary embodiment of the present general inventive concept.

The display chip IC according to an exemplary embodiment of the present general inventive concept may include a display driving circuit DDI and a touch sensing controller TSC. The display chip IC receives image data from an external host and a sensing signal from a touch screen panel.

The display driving circuit DDI generates gradation data to drive an actual display device, by processing the image data, and provides the gradation data to a display panel. The display driving circuit DDI may include the timing controller 110, the source driving unit 100, and the gate driving unit 130 of FIG. 1.

The touch sensing controller TSC may obtain touch data based on the sensing signal, and determine the point where the touch occurred based on the touch data, to provide the information to an external host.

The display chip IC in which the display driving circuit DDI and the touch sensing controller TSC are stacked may include the display panel and the touch screen panel that are integrally formed, or the display panel and the touch screen panel that are separated from each other.

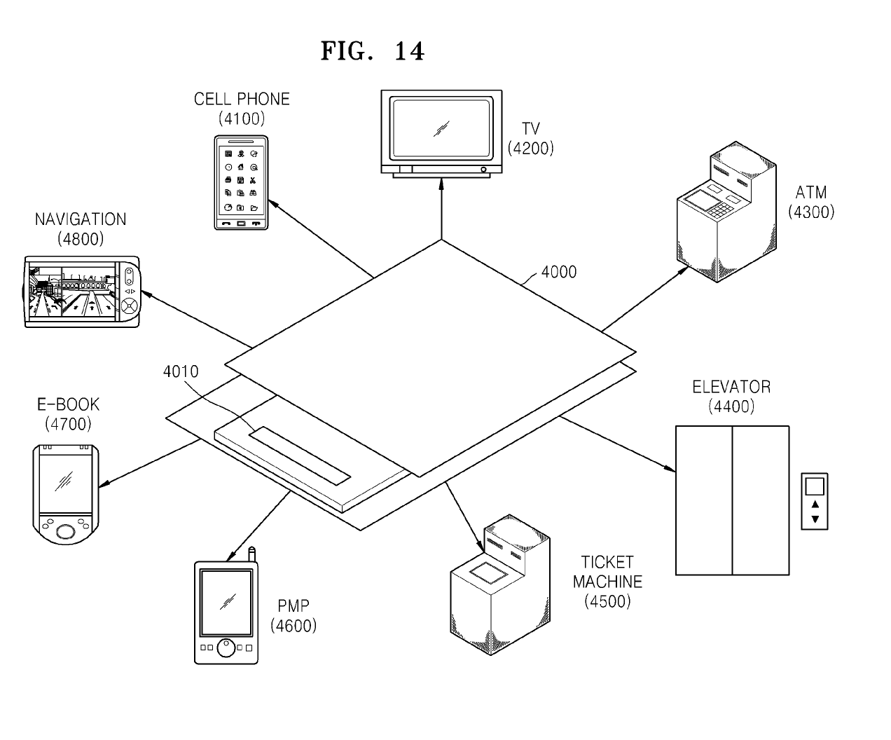

FIG. 13 is a view illustrating a display system according to an exemplary embodiment of the present general inventive concept.

Referring to FIG. 13, the display system 3000 may include a processor 3100 electrically connected to a system bus 3500, a display device 3200, a peripheral device 3300, and a memory 3400.

The processor 3100 may control a data input and output of the peripheral device 3300, the memory 3400, and the display device 3200. Also, the processor 3100 may image-process image data transmitted between the above devices.

The display device 3200 includes a panel 3210 and a driving circuit 3220. The display device 3200 stores image data applied by the system 3500 in a frame memory included inside the driving circuit 3220, and displays the image data on the panel 3210. The display device 3200 may be the display device 10 of FIG. 1.

The peripheral device 3300 may be a device that converts a video or a still image of cameras, scanners, and webcams into electrical signals. The image data obtained by the peripheral device 3300 may be stored in the memory 3400, or may be displayed in real time on the panel of the display device 3200.

The memory 3400 may include a volatile memory device such as a dynamic random access memory (DRAM) and/or a non-volatile memory device such as a flash memory device. The memory 3400 may include a DRAM, phase change random access memory (PRAM), magnetic random access memory (MRAM), resistive random access memory (ReRAM), ferroelectric random access memory (FRAM), a NOR flash memory, a NAND flash memory, and a fusion flash memory (e.g., a memory in which a static random access memory (SRAM) buffer, an NAND flash memory, and NOR interface logic are combined). The memory 3400 may store image data obtained from the peripheral device 3300 or store an image signal processed in the processor 3100.

The display system 3000 according to an exemplary embodiment of the present general inventive concept may be provided in mobile electronic goods such as smart phones. However, it is not limited thereto. The display system 3000 may be provided in various other kinds of electronic goods that display images.

FIG. 14 is a view illustrating diverse exemplary applications of electronic goods including a display device, according to an exemplary embodiment of the present general inventive concept.

The display device 4000 according to an exemplary embodiment of the present general inventive concept may be implemented in various electronic goods. The display device 4100 may be widely implemented in a television 4200, an automated teller machine (ATM) machine 4300 that automatically performs cash deposition and withdrawal at banks, an elevator 4400, a ticket machine 4500 that may be used for example in subway stations, a portable multimedia player (PMP) 4600, an e-book 4700, and a navigation unit 4800, as well as a cellular phone 4100. The display device 4000 according to the present exemplary embodiment of the present general inventive concept may operate with a system processor asynchronously. Thus, functions of the electronic goods may be improved by reducing a driving burden of the processor and enabling the processor to operate at high speed with low power consumption.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display device, comprising:
a timing controller to generate a plurality of data control signals;
a source driving unit to receive the plurality of data control signals from the timing controller and to generate a data voltage; and
a display panel to receive the data voltage and to output an image,
wherein the source driving unit transmits the data voltage to the display panel, through a plurality of data lines, with delays that are respectively different corresponding to each frame.

2. The display device of claim 1, wherein the display panel outputs the image by compensating the delays that are respectively different corresponding to each frame.

3. The display device of claim 1, wherein the source driving unit comprises a plurality of source drivers, and, the source driving unit comprising the plurality of source drivers generates the data voltage with delays that are respectively different.

4. The display device of claim 3, wherein the plurality of source drivers are respectively connected to the plurality of data lines, and, each of the plurality of data lines that is connected to each of the plurality of source drivers generates the data voltage with a delay that is different each independently.

5. The display device of claim 1, wherein the timing controller transmits the plurality of data control signals to the source driving unit with random delays.

6. The display device of claim 1, wherein the source driving unit comprises a plurality of source drivers, and, the timing controller transmits the plurality of data signals to the plurality of source drivers with random delays.

7. The display device of claim 1, wherein the source driving unit comprises a plurality of source channels that are respectively connected to the plurality of data lines, and, each of the plurality of source channels transmits the data voltage to the display panel with a delay that is different.

8. The display device of claim 1, further comprising a clock controller comprising:
a clock pattern generator to generate a clock pattern signal;
a clock generator to receive the clock pattern signal and to generate at least one preliminary clock signal;
a synchronization compensator to receive the clock pattern signal and to generate at least one compensation clock signal corresponding to a frequency of the at least one preliminary clock signal; and
a divider to generate at least one clock signal by merging the at least one preliminary clock signal received from the clock generator and the at least one compensation clock signal received from the synchronization compensator,
wherein the at least one clock signal is transmitted to the timing controller.

9. The display device of claim 8, wherein the at least one clock signal has a frequency within a predetermined range.

10. The display device of claim 8, wherein the clock pattern signal is predetermined in consideration of a frame frequency.

11. The display device of claim 8, wherein the clock pattern signal is changed in a horizontal line unit of the image output from the display panel or is changed in a frame unit.

12. The display device of claim 1, wherein the data control signal comprises color data comprising at least two pieces of sub-color data, and, the source driving unit transmits the data voltage to the display panel, with delays that are respectively different corresponding to each of the at least two pieces of sub-color data.

13. A display driving device, comprising:
a timing controller to generate a plurality of data control signals; and
a source driving unit to receive the plurality of data control signals from the timing controller and to generate a data voltage,
wherein the source driving unit transmits the data voltage to a display panel through a plurality of data lines, with delays that are respectively different corresponding to each frame.

14. The display driving device of claim 13, wherein the display panel outputs an image by compensating the delays that are respectively different corresponding to each frame.

15. The display driving device of claim 13, wherein the data control signal comprises color data comprising at least two pieces of sub-color data, and, the source driving unit transmits the data voltage to the display panel, with delays that are respectively different corresponding to each of the at least two pieces of sub-color data.

16. A display driving device, comprising:
a source driving unit to generate a data voltage based on a plurality of received data control signals corresponding to timing signals; and
a display panel to receive the data voltage through a plurality of data lines having delays that are respectively different corresponding to each frame.

17. The display device of claim 16, further comprising a timing controller to generate the plurality of data control signals.

18. The display device of claim 16, wherein the plurality of data control signals correspond to at least one of respective source channels, respective frames, and respective horizontal synchronization lines having different respective delays.

19. The display device of claim 16, wherein the timing signals correspond to at least one of data, a vertical synchronization signal, a horizontal synchronization signal, a clock signal, and a data enable signal.

20. The display device of claim 16, wherein the display panel outputs an image by a plurality of pixels by receiving the data voltage transmitted with the respective delays from the source driving unit and compensating the respective delays.
